(19) United States
(12) Patent Application Publication
(10) Pub. No.: US 2004/0208230 A1
(43) Pub. Date: Oct. 21, 2004

(54) Thermometer with image display

(76) Inventors: Tzong-Sheng Lee, Miao-Li (TW); Long-Der Chen, Hsin-Chu City (TW); Kuo-Hua Tseng, I-Lan (TW); Jia-Shing Wu, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/414,088

(22) Filed: Apr. 16, 2003

(51) Int. Cl. G01K 1/00

(52) U.S. Cl. 374/208; 374/100

(57) ABSTRACT

A thermometer with image display that has infrared radiation sensor and visible light sensor. Hence, the temperature indicated by the infrared radiation and the image indicated by the visible light is acquired simultaneously. Then, it is possible to decide whether correct area is detected and to analysis the detected area by the image.

### BACKGROUND OF THE INVENTION

1. Field of The Invention

The present invention is concerned with a thermometer with image display. Moreover, it is specifically related to a thermometer that uses the infrared radiation signals and the visible light signals simultaneously to provide the function of diagnosing with visible image.

2. Description of the Prior Art

Because the radiation radiated by the human-body temperature is the infrared radiation, the human-body temperature can be decided by receiving and analysising the infrared radiation radiated by the human-body. Particularly, the human-body temperature can be rapidly acquired while the used infrared radiation sensor is capable of precisely measured the temperature of only a small portion of the human body.

Based on the previous idea, the infrared ear thermometers become red-hot commercial products. By inserting the sensing portions of the infrared ear thermometers into the ear, the temperature is rapidly acquired. Moreover, because the infrared ear thermometers need only receive enough signals but need not to be thermal stability with the ambient human-body, the required measurement time can be smaller than one second. Hence, it is more convenient for measuring the body temperature of children. In general, as shown in FIG. 1A, the conventional infrared era thermometer has briefly two portions: infrared radiation detecting means 11 for detecting and sensing numerous infrared radiation signals and analyzing and processing means 12 for analyzing and processing the infrared radiation signals. Additional, for different commercial infrared ear thermometers, following portions are optional to be used: transmission means 13 (wire less or with wire), power source 14 and controlling interface means 15.

For the conventional infrared era thermometers, there are many present improvements. For example, more suitable outline for holding, more sensitive infrared radiation sensor, shorter measuring period, automatic memory function, automatically turn-off function and less consumed poser. But, till now, seldom improvements are present to ensure the measured temperature being the temperature of the correct portion of the human-body or to provide function(s) more than measured temperature.

However, according to the statistical data, about 5 percents of babies have the curved auditory canal. Hence, sometimes the measured temperature is not the temperature of ear membrane or the central nerve. Further, even there is no curved auditory canal, owing to the existence of ear wax or the improper operation, the measured temperature still is wrong sometimes. Besides, the conventional infrared era thermometer only can measure temperature but can provide the feature inside the ear. Hence, even the infrared radiation sensor is sensitive enough to measure the temperature in the one cubic-centimeters around the infrared radiation sensor, the conventional infrared era thermometer still can only find there is some portions of the ear becomes inflamed, but can not indicate which portions of the ear is sick.

Accordingly, the conventional infrared ear thermometer still is far away from being perfect, and then further research and development is necessary.

### SUMMARY OF THE INVENTION

One main purpose of the present invention is to provide a thermometer with image display. Moreover, the present invention is related to a thermometer being suitable for measure the temperature of openings of the human-body, such the ear, the mouse and the throat.

Another main purpose of the present invention is to provide a thermometer with image display. Moreover, the present invention is related to a thermometer that measure temperature and acquired only information(s) of the measured portion simultaneously.

A further purpose of the present invention is to provide a thermometer with image display. The embodiment improves some disadvantages of the conventional infrared era thermometer by receiving and process the infrared radiation signals and the visible light signals at the same time.

The present thermometer with image display that has infrared radiation sensor and visible light sensor. Hence, the temperature indicated by the infrared radiation and the image indicated by the visible light is acquired simultaneously. Then, beside acquire the human-body temperature, the invention still is possible to decide whether correct area is detected and to analyze the condition of the detected area by the detected image. For example, by using the detected image (feature) to decide the position of the infrared radiation sensor the present thermometer, it is possible to decide which portion is measured (especially while the infrared radiation sensor is sensitive enough). For example, by analyzing the detected feature, it is possible to diagnose the measured portion and to diagnose what induces the measured temperature.

To compare with the conventional infrared ear thermometer, the invention has at least the following advantages:

(1) Double informations are acquired by processing infrared radiation and visible light simultaneously.

Therefore, some conventional disadvantages induced by only infrared radiation being processed can be improved or even be perfectly prevented.

(2) The location of the infrared radiation sensor can be decided by processing the visible light signals.

Therefore, the risk of measuring temperature of wrong portion of human-body (such as induced by curved auditory canal or improper operation) can be improved or even be perfectly prevented.

(3) The condition of the measured portion of human portions can be diagnosed by processing the visible light.

Therefore, by using an infrared radiation sensor with enough sensitivity, the present thermometer can acquire an average temperature of a portion of the human-body (such as ear or mouse), and further can measure the distribution of temperature among the measured portion.

(4) Both the infrared radiation sensor and the visible light sensor are commercial products, and how to separate the infrared radiation and the visible light is the well-know technology.

Therefore, the present thermometer can be performed by using current commercial products and well-know technology. In other words, the invention only need a creative and original opinion to do so, the invention has less technology difficulty and less increased cost.

(5) Both the visible light and the infrared radiation can be used to form a clear feature (the only limitation is the resolution of the corresponding sensor).

Therefore, the present thermometer is not only a device for measuring temperature. Moreover, the present thermometer can play as a compact endoscopes.

(6) The transmission technology (both wireless and with wire) are rapidly improved, and the storage technology also rapidly improved.

Therefore, the present thermometer can has (or is connected to) a device for recording, transmitting and storing feature. Hence, both temperature and feature can be transmitted into electronic records, and then the present thermometer is suitable for electronic able medical history of patients.

### BRIEF DESCRIPTION OF THE DRAWINGS

FIG. 1A to FIG. 1B show two popular essential structures of the conventional infrared ear thermometer;

FIG. 2A to FIG. 2E show some available essential structures of one present thermometer with image display; and

FIG. 3A to FIG. 3D show some available essential structures of another present thermometer with image display.

### DESCRIPTION OF THE PREFERRED EMBODIMENT

Some embodiments of the invention are described below. However, except the present details, the invention can also be applied in other embodiments. Hence, the scope of the invention is not limited by the following embodiments, but is decided by the present claims.

Initially, the inventors emphasize the essential difference between the conventional infrared ear thermometer and the conventional mercury thermometer is the following: the infrared ear thermometer only need receive numerous infrared radiation signals from the ambient environment, but the conventional mercury thermometer must be thermal stability with the ambient environment before it can work. In other words, the most significantly advantage of the infrared ear thermometer is that the infrared ear thermometer only need receive infrared radiation signals but need not react with the ambient environment for achieving thermal stability. Therefore, any improvement of the infrared ear thermometer cannot change the main character “only receive signals but not react”.

Further, the inventors emphasize the previous character being based on the fact that the infrared radiation is radiated by the human-body and is proportional to the human-body temperature. Of course, the application of the infrared ear thermometer cannot change the temperature of the measured portions, such as the human-body temperature inside ears. However, the inventors particularly emphasize that the character should be suitable for kinds of electromagnetic radiation, no matter the infrared radiation, the ultraviolet radiation, the microwave or the visible light.

Therefore, the inventors provide a solution to improve the previous disadvantages of the conventional infrared ear thermometer: detect the infrared radiation and the visible light simultaneously. Herein, both the infrared radiation and the visible light is the electromagnetic radiation, and then the detection can be finished in a ver short period without inducing significant variation of the temperature of the measured portions. Indisputably, after the visible light is measured too, the information acquired by the present thermometer only is the human-body temperature indicated by the infrared radiation, but also us the visible feature of the measured portion provided by the visible light. Hence, even there are curved auditory canal and/or ear waxes, the probability of improper measurement is clearly decreased. Moreover, by analyzing the visible feature, some information about the condition of the measured portion are further provided (for example, which part of the ear becomes inflamed).

Certainly, if the infrared radiation sensor is sensible enough, the acquired informations not only is a average human-body temperature among the measured portion of the human-body, but also is a feature of thermal distribution among the measured portion. Then, further informations are provided by the present thermometer. Clearly, the informations provided by the visible light still are very helpful for there are many informations can not be provided only by the temperature distribution. For example, the shape and the color of the ear wax, the shape and the stripe of the rashes in the auditory canal.

Of course, the key point(s) of the present thermometer is related to how to acquired the temperature and the image by using both the infrared radiation and the visible light simultaneously. Hence, the main character(s) of the present thermometer is independent on the details of the sensor(s), the device(s) for processing signals and the transmission of the informations related to the feature, the human-body temperature, and so on. In other words, the main character(s) of the invention is related on the creative idea that integrates the feature of the visible light to the conventional infrared era thermometer. Hence, the invention can use all related prior arts, such as the light sensor and the image processing technology, and then the present invention has no difficult technology problem or increased cost problem.

Besides, because all of the human-body is visible on the visible light and the infrared radiation, there is no reason that the present thermometer can only be used to the human-body temperature in the ear. The invention can be used to measure any portion of the human-body, such as armpit, mouse, nostril and anus. Surely, to avoid the infrared radiation is interfered by the skin and to bring the visible light into fully play, the invention is very suitable for some portions of the human-body that the thin membrane can be directly measured, such as mouse, nostril and anus.

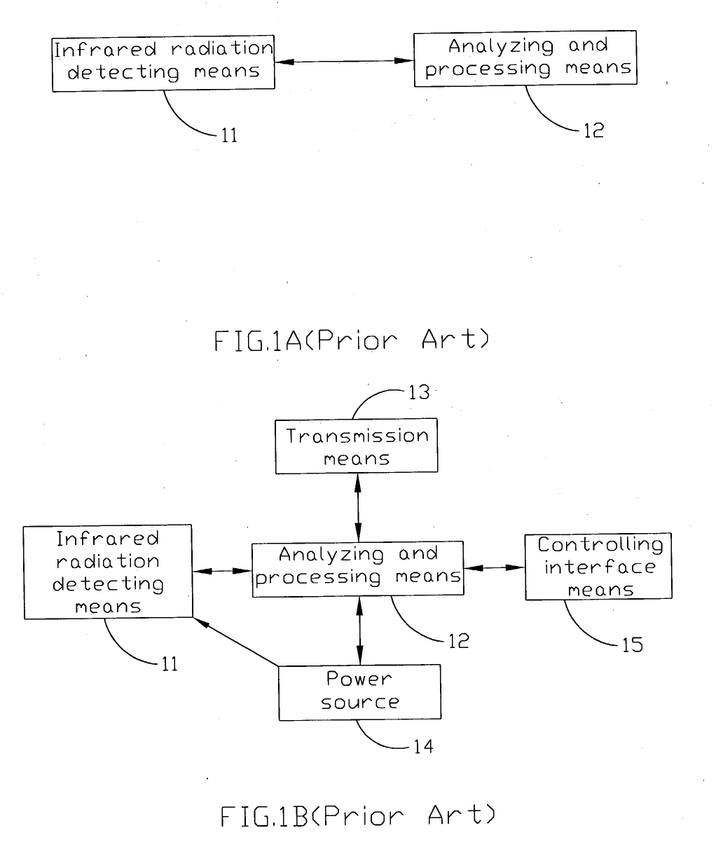

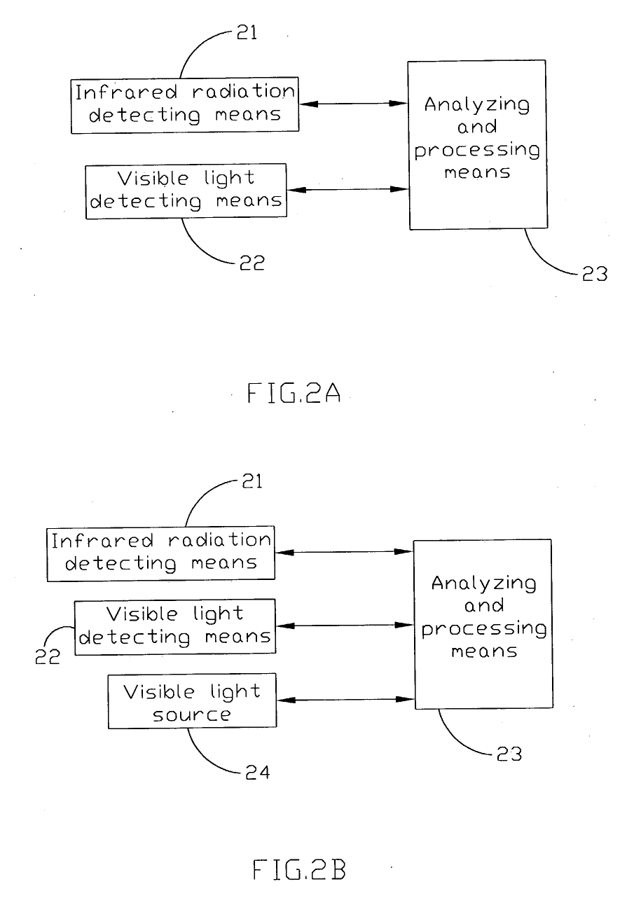

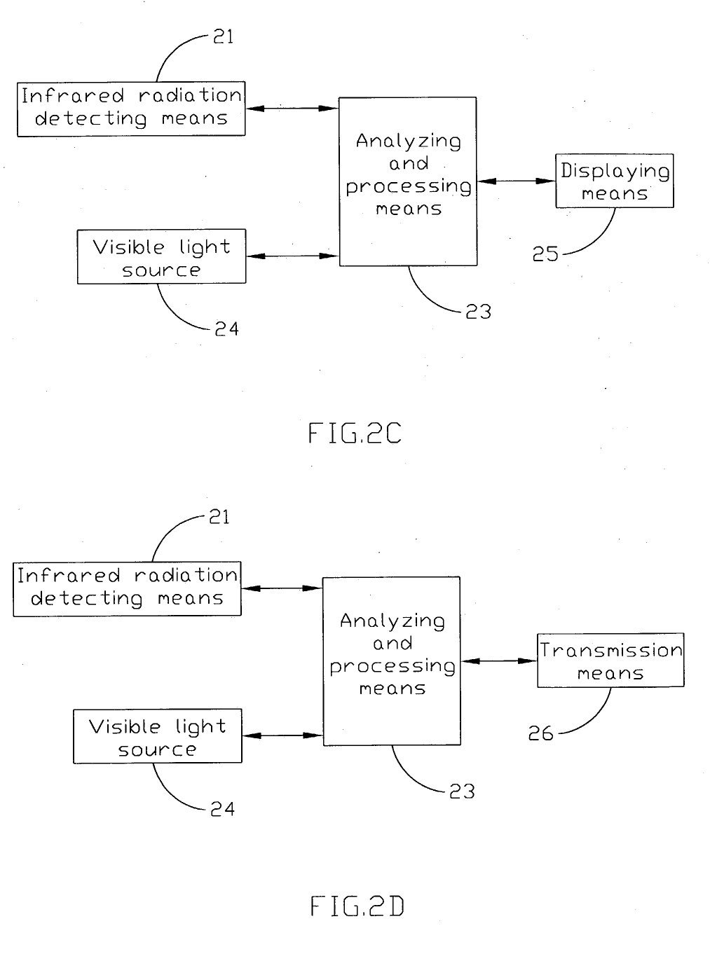

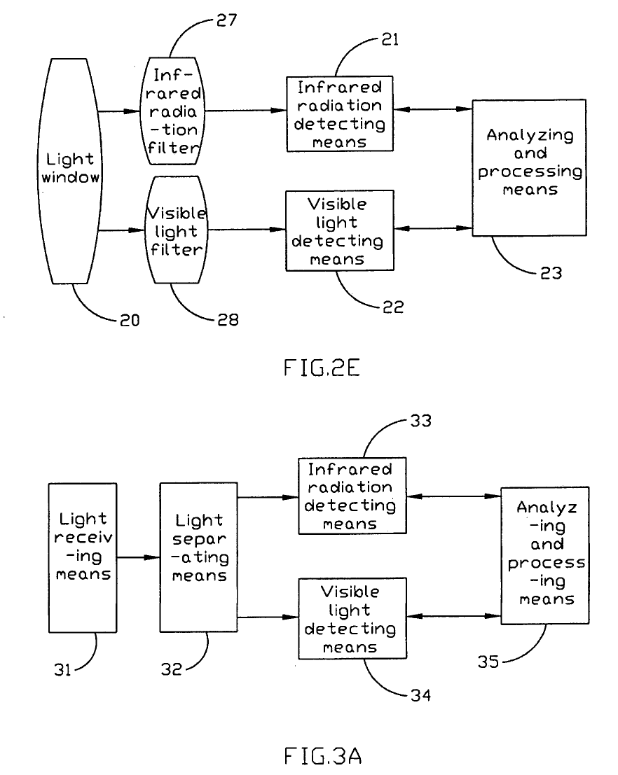

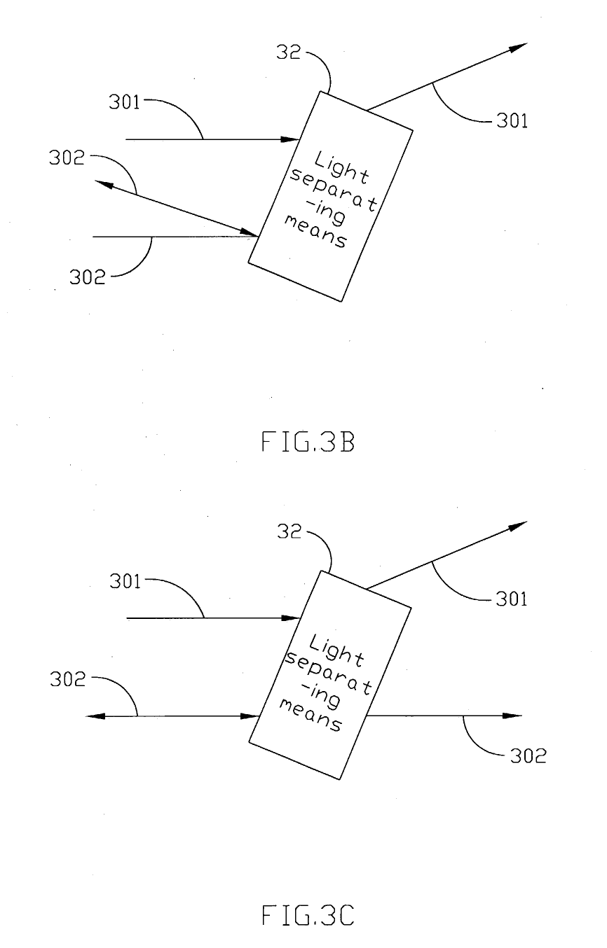

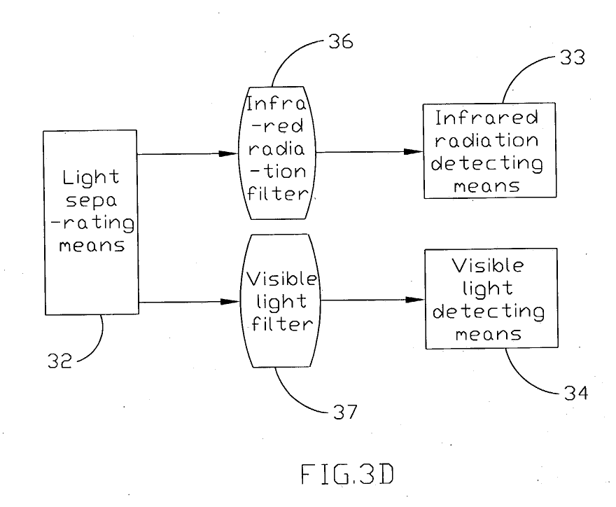

According to the previous discussion, one preferred embodiment of the invention is thermometer with image display. As shown in FIG. 2A, the present thermometer with image display has at least the infrared radiation detecting means 21 for receiving and sensing numerous infrared radiation signals, the visible light detecting means 22 for receiving and sensing numerous visible light signals, and the analyzing and processing means 23 for analyzing and processing the infrared radiation signals and the visible light signals. By comparing FIG. 2A and FIG. 1A, significantly, the main character of the embodiment is the visible light detecting means 22. Surely, the requirement of treating the visible light signals must change the analyzing and processing means 23, such that analyzing and processing means 12 is only is a portion of the analyzing and processing means, 23.

In the embodiment, the visible light signals correspond to (can be used to form) a visible figure, and the infrared radiation signals correspond to (can be used to form) a infrared radiation figure (or a thermal distribution feature) if the infrared radiation means 21 is sensible enough. In general, the infrared radiation detecting means 23 is an infrared radiation thermometer, and the visible light detecting means 22 is a CCD (charger coupled devices) sensor and/or a CMOS (metal oxide semiconductor) sensor.

What are said above are only the preferred embodiment of the invention and they are not used to limit the claims of the invention; Any changes or modifications that do not depart from the essence displayed by the invention should be limited in what is claimed in the following.

1. A thermometer with image display, comprising:
infrared radiation detecting means for receiving and sensing a plurality of infrared radiation signals;
visible light detecting means for receiving and sensing a plurality of visible light signals; and
analyzing and processing means for analyzing and processing said infrared radiation signals and said visible light signals.

2. The thermometer with image display of claim 1, wherein said plurality of visible light signals corresponding to a visible figure.

3. The thermometer with image display of claim 1, wherein said plurality of infrared radiation signals corresponding to an infrared radiation figure.

4. The thermometer with image display of claim 1, wherein said infrared radiation detecting means is an infrared radiation thermometer.

5. The thermometer with image display of claim 1, wherein said visible light detecting means is selected from the group Page 4 of 25 consisting of CCD sensor and CMOS sensor.

6. The thermometer with image display of claim 1, further comprising an visible light source, wherein said visible light source is selected from the group consisting of high lightness LED and tungsten-filament bulb.

7. The thermometer with image display of claim 1, further comprising a display figure for displaying a temperature corresponding to said plurality of infrared radiation signals and a figure corresponding to said plurality of visible light signals.

8. The thermometer with image display of claim 1, further comprising a transmission means for transmitting said plurality of infrared radiation signals and said plurality of visible light signals, wherein said transmission means is selected from the group consisting of wireless transmission device and wire transmission device.

9. A thermometer with image display, comprising:
light receiving means for receiving a plurality of infrared light signals and a plurality of visible light signals;
light separating means for separating said plurality of infrared light signals and said plurality of visible light signals;
infrared radiation detecting means for detecting said plurality of infrared radiation signals;
visible light detecting means for detecting said plurality of visible light signals; and
analyzing and processing means for analyzing and processing said plurality of infrared radiation signals and said plurality of visible light signals.

10. The thermometer with image display of claim 9, wherein said plurality of visible light signals corresponds to a visible feature.

11. The thermometer with image display of claim 9, wherein said plurality of infrared radiation signals corresponds to an infrared radiation feature.

12. The thermometer with image display of claim 9, wherein said infrared radiation detecting means is an infrared radiation thermometer.

13. The thermometer with image display of claim 9, wherein said visible light detecting means is selected from the group consisting of the following: CCD sensor and CMOS sensor.

14. The thermometer with image display of claim 9, wherein said light separating means selected from the group consisting of the: germanium windows, silicon windows and beam splitter.

15. The thermometer with image display of claim 9, wherein the function of said light separating means is selected from the group consisting of the said plurality of infrared radiation signals passing through said light separating means but said plurality of visible light signals are reflected by said light separating means, and said plurality of visible light signals passing through said light separating means but said plurality of infrared radiation signals are reflected by said light separating means.

16. The thermometer with image display of claim 9, wherein the propagating direction of said plurality of infrared radiation signals is different from the propagation direction of said plurality of visible light signals after both said plurality of infrared radiation signals and said plurality of visible light signals pass through said light separating means.

17. The thermometer with image display of claim 9, wherein the propagating direction of said plurality of infrared radiation signals is different from the propagation direction of said plurality of visible light signals after both said plurality of infrared radiation signals and said plurality of visible light signals are reflected by said light separating means.

18. The thermometer with image display of claim 9, further comprising an visible light source, wherein said visible light source is selected from the group consisting of high lightness LED and tungsten-filament bulb.

19. The thermometer with image display of claim 9, further comprising a displaying means for displaying a temperature corresponding to said plurality of infrared radiation signals and a figure corresponding to said plurality of visible light signals.

20. The thermometer with image display of claim 9, further comprising a transmission means for transmitting said plurality of infrared radiation signals and said plurality of visible light signals, wherein said transmission is selected from the group consisting of the wireless transmission device and wire transmission device.

21. A thermometer with image display, comprising:
visible light source means for illuminating a measure portion;
infrared radiation detecting means for receiving and sensing a plurality of infrared radiation signals from said measured portion, wherein said plurality of infrared radiation signals corresponding to a temperature in said measured portion;
visible light detecting means for receiving and sensing a plurality of visible light signals from said measured portion, wherein said plurality of visible light signals corresponding to a figure in said measured portion;
analyzing and processing means for analyzing and processing said plurality of infrared radiation signals and said plurality of visible light signal; and
displaying means for displaying said temperature and said figure.

22. The thermometer with image display of claim 21, wherein said visible light source is a light emitting diode (LED).

23. The thermometer with image display of claim 21, wherein said visible light source is a tungsten-filament bulb.

24. The thermometer with image display of claim 21, wherein said infrared radiation detecting means is an infrared radiation thermometer.

25. The thermometer with image display of claim 21, wherein said visible light detecting means is charge coupled device sensor (CCD sensor).

26. The thermometer with image display of claim 21, wherein said visible light detecting means is CMOS sensor (complementary metal oxide semiconductor sensor).

27. The thermometer with image display of claim 21, further comprising a transmission means for transmitting said plurality of infrared signals and said plurality of visible light signals.

28. The thermometer with image display of claim 27, wherein said transmission means is a wireless transmission device.

29. The thermometer with image display of claim 27, wherein said transmitting means is a wire transmission device.

30. A thermometer with image display, comprising:
visible light source means for illuminating a measured portion;
light receiving means for receiving a plurality of infrared light signals and a plurality of visible light signals from said measured portion;
light separating means for separating said plurality of infrared light signals and said plurality of visible light signals from said light receiving means;
infrared radiation detecting means for receiving and sensing a plurality of infrared radiation signals from said light separating means, wherein said plurality of infrared radiation signals corresponding to a temperature in said measured portion;
visible light detecting means for receiving and sensing a plurality of visible light signals, wherein said plurality of visible light signals corresponding to a figure in said measured portion;
analyzing and processing means for analyzing and processing said plurality of infrared radiation signals and said plurality of visible light signals; and
displaying means for displaying said temperature and said figure.

31. The thermometer with image display of claim 30, wherein said visible light source is a light emitting diode (LED).

32. The thermometer with image display of claim 30, wherein said visible light source is a tungsten-filament bulb.

33. The thermometer with image display of claim 30, wherein said light separating means is selected from the group consisting of a germanium windows, a silicon windows, and a beam splitter.

34. The thermometer with image display of claim 30, wherein said infrared radiation detecting means is an infrared radiation thermometer.

35. The thermometer with image display of claim 30, wherein said visible light detecting means is a charge coupled device sensor (CCD sensor).

36. The thermometer with image display of claim 30, wherein said visible light detecting means is a complementary metal oxide semiconductor sensor (CMOS sensor).
